(19) United States
(12) Patent Application Publication
(10) Pub. No.: US 2023/0419844 A1
(43) Pub. Date: Dec. 28, 2023

(54) APPARATUS, METHODS, AND COMPUTER PROGRAMS

(71) Applicant: Nokia Technologies Oy, Espoo (FI)

(72) Inventors: Man Hung NG, Swindon, Wiltshire (GB); Zhilan XIONG, Bristol (GB)

(21) Appl. No.: 18/251,586

(22) PCT Filed: Nov. 13, 2020
(86) PCT No.: PCT/EP2020/082016

§ 371 Date: May 3, 2023

(51) Int. Cl. G08G 5/00; G05D 1/10

(52) U.S. Cl. CPC G08G 5/0069; G05D 1/104; B64U 10/00

(57) ABSTRACT

There is provided an apparatus for an unmanned aerial vehicle, the apparatus comprising; means for coordinating flights of unmanned aerial vehicles in a flight group comprising the unmanned aerial vehicle; means for transmitting at least one request to at least one of the unmanned aerial vehicles for a new controller of the flight group, wherein the new controller is to take over coordinating said flights from the unmanned aerial vehicle; means for receiving at least one response to the at least one request; means for selecting one of the at least one of unmanned aerial vehicles to be the new controller of the flight group using the at least one response; and means for sending an identifier of the new controller to the unmanned aerial vehicles.

### FIELD

The present disclosure relates to apparatus, methods, and computer programs, and in particular but not exclusively to apparatus, methods and computer programs for network apparatuses.

### BACKGROUND

A communication system can be seen as a facility that enables communication sessions between two or more entities such as user terminals, access nodes and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Content may be multicast or uni-cast to communication devices.

A user can access the communication system by means of an appropriate communication device or terminal. A communication device of a user is often referred to as user equipment (UE) or user device. The communication device may access a carrier provided by an access node, and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known is the long-term evolution (LTE) or the Universal Mobile Telecommunications System (UMTS) radio-access technology. Another example communication system is so called 5G system that allows user equipment (UE) or user device to contact a 5G core via e.g. new radio (NR) access technology or via other access technology such as Untrusted access to 5GC or wireline access technology.

### SUMMARY

According to a first aspect, there is provided an apparatus for an unmanned aerial vehicle, the apparatus comprising; means for coordinating flights of unmanned aerial vehicles in a flight group comprising the unmanned aerial vehicle; means for transmitting at least one request to at least one of the unmanned aerial vehicles for a new controller of the flight group, wherein the new controller is to take over coordinating said flights from the unmanned aerial vehicle; means for receiving at least one response to the at least one request; means for selecting one of the at least one of unmanned aerial vehicles to be the new controller of the flight group using the at least one response; and means for sending an identifier of the new controller to the unmanned aerial vehicles.

Each of said at least one response may comprise a respective identifier of the unmanned aerial vehicle that sent said at least one response.

At least one of said at least one responses may comprise information on at least one state of the unmanned aerial vehicle associated with the at least one response, and said means for selecting may comprise means for selecting said one of the at least one of the unmanned aerial vehicles using the information on at least one state.

The at least one state may comprise any of: a battery level of the associated unmanned aerial vehicle; a processing capability of the associated unmanned aerial vehicle; artificial intelligence capabilities of the associated unmanned aerial vehicle; and global positioning system capabilities of the associated unmanned aerial vehicle.

The apparatus may comprise means for controlling the flight of the new controller to take a central position within the flight group.

The apparatus may comprise means for swapping positions in the flight group with the new controller.

The apparatus may comprise means for instructing the new controller to start coordinating flights of unmanned aerial vehicles in the flight group.

The apparatus may comprise: means for receiving an indication that a first unmanned aerial vehicle in the flight group has not received flight control information from the apparatus for a predetermined time; and means for sending flight control information to the first unmanned aerial vehicle using a transmission that increases the likelihood of reception by the first unmanned aerial vehicle relative to previous transmissions to the first unmanned aerial vehicle.

The indication may be received from at least one of: the first unmanned aerial vehicle; and a ground-based controller.

According to a second aspect, there is provided an apparatus for an unmanned aerial vehicle, the apparatus comprising: means for receiving an identifier of a new controller of a flight group comprising the unmanned aerial vehicle from a controlling unmanned aerial vehicle configured to coordinate flights of unmanned aerial vehicles in the flight group, wherein the new controller is to take over coordinating said flights from the controlling unmanned aerial vehicle.

The apparatus may comprise: means for receiving a request to be the new controller from the controlling unmanned aerial vehicle; means for determining whether to volunteer to be the new controller; and means for transmitting the result of said determining to the controlling unmanned aerial vehicle along with an identifier for said unmanned aerial vehicle.

Said result of said determining may be transmitted with information on at least one state of the unmanned aerial vehicle.

The at least one state may comprise any of: a battery level of the unmanned aerial vehicle; a processing capability of the unmanned aerial vehicle; artificial intelligence capabilities of the unmanned aerial vehicle; and global positioning system capabilities of the unmanned aerial vehicle.

The apparatus may comprise means for receiving an instruction from the controlling unmanned aerial vehicle to take a central position within the flight group.

The apparatus may comprise means for receiving an instruction from the controlling unmanned aerial vehicle to swap positions in the flight group with the controlling unmanned aerial vehicle.

The apparatus may comprise means for receiving an instruction from the controlling unmanned aerial vehicle to start coordinating flights of unmanned aerial vehicles in the flight group.

The apparatus may comprise means for transmitting an indication that the unmanned aerial vehicle in the flight group has not received flight control information from the controlling unmanned aerial vehicle for a predetermined time.

The indication may be transmitted to at least one of: the controlling unmanned aerial vehicle; and a ground-based controller.

According to a third aspect, there is provided an apparatus for an unmanned aerial vehicle, the apparatus comprising: at least one processor; and at least one memory comprising computer code that, when executed by the at least one processor, causes the apparatus to: coordinate flights of unmanned aerial vehicles in a flight group comprising the unmanned aerial vehicle; transmit at least one request to at least one of the unmanned aerial vehicles for a new controller of the flight group, wherein the new controller is to take over coordinating said flights from the unmanned aerial vehicle; receive at least one response to the at least one request; select one of the at least one of unmanned aerial vehicles to be the new controller of the flight group using the at least one response; and send an identifier of the new controller to the unmanned aerial vehicles.

Each of said at least one response may comprise a respective identifier of the unmanned aerial vehicle that sent said at least one response.

At least one of said at least one responses may comprise information on at least one state of the unmanned aerial vehicle associated with the at least one response, and said selecting may comprise selecting said one of the at least one of the unmanned aerial vehicles using the information on at least one state.

The at least one state may comprise any of: a battery level of the associated unmanned aerial vehicle; a processing capability of the associated unmanned aerial vehicle; artificial intelligence capabilities of the associated unmanned aerial vehicle; and global positioning system capabilities of the associated unmanned aerial vehicle.

The apparatus may be caused to control the flight of the new controller to take a central position within the flight group.

The apparatus may be caused to swap positions in the flight group with the new controller.

The apparatus may be caused to instruct the new controller to start coordinating flights of unmanned aerial vehicles in the flight group.

The apparatus may be caused to: receive an indication that a first unmanned aerial vehicle in the flight group has not received flight control information from the apparatus for a predetermined time; and send flight control information to the first unmanned aerial vehicle using a transmission that increases the likelihood of reception by the first unmanned aerial vehicle relative to previous transmissions to the first unmanned aerial vehicle.

The indication may be received from at least one of: the first unmanned aerial vehicle; and a ground-based controller.

According to a fourth aspect there is provided an apparatus for an unmanned aerial vehicle, the apparatus comprising: at least one processor; and at least one memory comprising computer code that, when executed by the at least one processor, causes the apparatus to: receive an identifier of a new controller of a flight group comprising the unmanned aerial vehicle from a controlling unmanned aerial vehicle configured to coordinate flights of unmanned aerial vehicles in the flight group, wherein the new controller is to take over coordinating said flights from the controlling unmanned aerial vehicle.

The apparatus may be caused to: receive a request to be the new controller from the controlling unmanned aerial vehicle; determine whether to volunteer to be the new controller; and transmit the result of said determining to the controlling unmanned aerial vehicle along with an identifier for said unmanned aerial vehicle.

Said result of said determining may be transmitted with information on at least one state of the unmanned aerial vehicle.

The at least one state may comprise any of: a battery level of the unmanned aerial vehicle; a processing capability of the unmanned aerial vehicle; artificial intelligence capabilities of the unmanned aerial vehicle; and global positioning system capabilities of the unmanned aerial vehicle.

The apparatus may be caused to receive an instruction from the controlling unmanned aerial vehicle to take a central position within the flight group.

The apparatus may be caused to receive an instruction from the controlling unmanned aerial vehicle to swap positions in the flight group with the controlling unmanned aerial vehicle.

The apparatus may be caused to receive an instruction from the controlling unmanned aerial vehicle to start coordinating flights of unmanned aerial vehicles in the flight group.

The apparatus may be caused to transmit an indication that the unmanned aerial vehicle in the flight group has not received flight control information from the controlling unmanned aerial vehicle for a predetermined time.

The indication may be transmitted to at least one of: the controlling unmanned aerial vehicle; and a ground-based controller.

According to a fifth aspect, there is provided a method for an apparatus for an unmanned aerial vehicle, the method comprising: coordinating flights of unmanned aerial vehicles in a flight group comprising the unmanned aerial vehicle; transmitting at least one request to at least one of the unmanned aerial vehicles for a new controller of the flight group, wherein the new controller is to take over coordinating said flights from the unmanned aerial vehicle; receiving at least one response to the at least one request; selecting one of the at least one of unmanned aerial vehicles to be the new controller of the flight group using the at least one response; and sending an identifier of the new controller to the unmanned aerial vehicles.

Each of said at least one response may comprise a respective identifier of the unmanned aerial vehicle that sent said at least one response.

At least one of said at least one responses may comprise information on at least one state of the unmanned aerial vehicle associated with the at least one response, and said selecting may comprise selecting said one of the at least one of the unmanned aerial vehicles using the information on at least one state.

The at least one state may comprise any of: a battery level of the associated unmanned aerial vehicle; a processing capability of the associated unmanned aerial vehicle; artificial intelligence capabilities of the associated unmanned aerial vehicle; and global positioning system capabilities of the associated unmanned aerial vehicle.

The method may comprise controlling the flight of the new controller to take a central position within the flight group.

The method may comprise swapping positions in the flight group with the new controller.

The method may comprise instructing the new controller to start coordinating flights of unmanned aerial vehicles in the flight group.

The method may comprise: receiving an indication that a first unmanned aerial vehicle in the flight group has not received flight control information from the apparatus for a predetermined time; and sending flight control information to the first unmanned aerial vehicle using a transmission that increases the likelihood of reception by the first unmanned aerial vehicle relative to previous transmissions to the first unmanned aerial vehicle.

The indication may be received from at least one of: the first unmanned aerial vehicle; and a ground-based controller.

According to a sixth aspect, there is provided a method for an apparatus for an unmanned aerial vehicle, the method comprising: receiving an identifier of a new controller of a flight group comprising the unmanned aerial vehicle from a controlling unmanned aerial vehicle configured to coordinate flights of unmanned aerial vehicles in the flight group, wherein the new controller is to take over coordinating said flights from the controlling unmanned aerial vehicle.

The method may comprise: receiving a request to be the new controller from the controlling unmanned aerial vehicle; determining whether to volunteer to be the new controller; and transmitting the result of said determining to the controlling unmanned aerial vehicle along with an identifier for said unmanned aerial vehicle.

Said result of said determining may be transmitted with information on at least one state of the unmanned aerial vehicle.

The at least one state may comprise any of: a battery level of the unmanned aerial vehicle; a processing capability of the unmanned aerial vehicle; artificial intelligence capabilities of the unmanned aerial vehicle; and global positioning system capabilities of the unmanned aerial vehicle.

The method may comprise receiving an instruction from the controlling unmanned aerial vehicle to take a central position within the flight group.

The method may comprise receiving an instruction from the controlling unmanned aerial vehicle to swap positions in the flight group with the controlling unmanned aerial vehicle.

The method may comprise receiving an instruction from the controlling unmanned aerial vehicle to start coordinating flights of unmanned aerial vehicles in the flight group.

The method may comprise transmitting an indication that the unmanned aerial vehicle in the flight group has not received flight control information from the controlling unmanned aerial vehicle for a predetermined time.

The indication may be transmitted to at least one of: the controlling unmanned aerial vehicle; and a ground-based controller.

According to a seventh aspect, there is provided an apparatus for an unmanned aerial vehicle, the apparatus comprising; coordinating circuitry for coordinating flights of unmanned aerial vehicles in a flight group comprising the unmanned aerial vehicle; transmitting circuitry for transmitting at least one request to at least one of the unmanned aerial vehicles for a new controller of the flight group, wherein the new controller is to take over coordinating said flights from the unmanned aerial vehicle; receiving circuitry for receiving at least one response to the at least one request; selecting circuitry for selecting one of the at least one of unmanned aerial vehicles to be the new controller of the flight group using the at least one response; and sending circuitry for sending an identifier of the new controller to the unmanned aerial vehicles.

Each of said at least one response may comprise a respective identifier of the unmanned aerial vehicle that sent said at least one response.

At least one of said at least one responses may comprise information on at least one state of the unmanned aerial vehicle associated with the at least one response, and said selecting circuitry may comprise selecting circuitry for selecting said one of the at least one of the unmanned aerial vehicles using the information on at least one state.

The at least one state may comprise any of: a battery level of the associated unmanned aerial vehicle; a processing capability of the associated unmanned aerial vehicle; artificial intelligence capabilities of the associated unmanned aerial vehicle; and global positioning system capabilities of the associated unmanned aerial vehicle.

The apparatus may comprise controlling circuitry for controlling the flight of the new controller to take a central position within the flight group.

The apparatus may comprise swapping circuitry for swapping positions in the flight group with the new controller.

The apparatus may comprise instructing circuitry for instructing the new controller to start coordinating flights of unmanned aerial vehicles in the flight group.

The apparatus may comprise: receiving circuitry for receiving an indication that a first unmanned aerial vehicle in the flight group has not received flight control information from the apparatus for a predetermined time; and sending circuitry for sending flight control information to the first unmanned aerial vehicle using a transmission that increases the likelihood of reception by the first unmanned aerial vehicle relative to previous transmissions to the first unmanned aerial vehicle.

The indication may be received from at least one of: the first unmanned aerial vehicle; and a ground-based controller.

According to an eighth aspect, there is provided an apparatus for an unmanned aerial vehicle, the apparatus comprising: receiving circuitry for receiving an identifier of a new controller of a flight group comprising the unmanned aerial vehicle from a controlling unmanned aerial vehicle configured to coordinate flights of unmanned aerial vehicles in the flight group, wherein the new controller is to take over coordinating said flights from the controlling unmanned aerial vehicle.

The apparatus may comprise: receiving circuitry for receiving a request to be the new controller from the controlling unmanned aerial vehicle; determining circuitry for determining whether to volunteer to be the new controller; and transmitting circuitry for transmitting the result of said determining to the controlling unmanned aerial vehicle along with an identifier for said unmanned aerial vehicle.

Said result of said determining may be transmitted with information on at least one state of the unmanned aerial vehicle.

The at least one state may comprise any of: a battery level of the unmanned aerial vehicle; a processing capability of the unmanned aerial vehicle; artificial intelligence capabilities of the unmanned aerial vehicle; and global positioning system capabilities of the unmanned aerial vehicle.

The apparatus may comprise receiving circuitry for receiving an instruction from the controlling unmanned aerial vehicle to take a central position within the flight group.

The apparatus may comprise receiving circuitry for receiving an instruction from the controlling unmanned aerial vehicle to swap positions in the flight group with the controlling unmanned aerial vehicle.

The apparatus may comprise receiving circuitry for receiving an instruction from the controlling unmanned aerial vehicle to start coordinating flights of unmanned aerial vehicles in the flight group.

The apparatus may comprise transmitting circuitry for transmitting an indication that the unmanned aerial vehicle in the flight group has not received flight control information from the controlling unmanned aerial vehicle for a predetermined time.

The indication may be transmitted to at least one of: the controlling unmanned aerial vehicle; and a ground-based controller.

According to a ninth aspect, there is provided non-transitory computer readable medium comprising program instructions for causing an apparatus for an unmanned aerial to perform at least the following: coordinate flights of unmanned aerial vehicles in a flight group comprising the unmanned aerial vehicle; transmit at least one request to at least one of the unmanned aerial vehicles for a new controller of the flight group, wherein the new controller is to take over coordinating said flights from the unmanned aerial vehicle; receive at least one response to the at least one request; select one of the at least one of unmanned aerial vehicles to be the new controller of the flight group using the at least one response; and send an identifier of the new controller to the unmanned aerial vehicles.

Each of said at least one response may comprise a respective identifier of the unmanned aerial vehicle that sent said at least one response.

At least one of said at least one responses may comprise information on at least one state of the unmanned aerial vehicle associated with the at least one response, and said selecting may comprise selecting said one of the at least one of the unmanned aerial vehicles using the information on at least one state.

The at least one state may comprise any of: a battery level of the associated unmanned aerial vehicle; a processing capability of the associated unmanned aerial vehicle; artificial intelligence capabilities of the associated unmanned aerial vehicle; and global positioning system capabilities of the associated unmanned aerial vehicle.

The apparatus may be caused to control the flight of the new controller to take a central position within the flight group.

The apparatus may be caused to swap positions in the flight group with the new controller.

The apparatus may be caused to instruct the new controller to start coordinating flights of unmanned aerial vehicles in the flight group.

The apparatus may be caused to: receive an indication that a first unmanned aerial vehicle in the flight group has not received flight control information from the apparatus for a predetermined time; and send flight control information to the first unmanned aerial vehicle using a transmission that increases the likelihood of reception by the first unmanned aerial vehicle relative to previous transmissions to the first unmanned aerial vehicle.

The indication may be received from at least one of: the first unmanned aerial vehicle; and a ground-based controller.

According to a tenth aspect there is provided non-transitory computer readable medium comprising program instructions for causing an apparatus for an unmanned aerial to perform at least the following: receive an identifier of a new controller of a flight group comprising the unmanned aerial vehicle from a controlling unmanned aerial vehicle configured to coordinate flights of unmanned aerial vehicles in the flight group, wherein the new controller is to take over coordinating said flights from the controlling unmanned aerial vehicle.

The apparatus may be caused to: receive a request to be the new controller from the controlling unmanned aerial vehicle; determine whether to volunteer to be the new controller; and transmit the result of said determining to the controlling unmanned aerial vehicle along with an identifier for said unmanned aerial vehicle.

Said result of said determining may be transmitted with information on at least one state of the unmanned aerial vehicle.

The at least one state may comprise any of: a battery level of the unmanned aerial vehicle; a processing capability of the unmanned aerial vehicle; artificial intelligence capabilities of the unmanned aerial vehicle; and global positioning system capabilities of the unmanned aerial vehicle.

The apparatus may be caused to receive an instruction from the controlling unmanned aerial vehicle to take a central position within the flight group.

The apparatus may be caused to receive an instruction from the controlling unmanned aerial vehicle to swap positions in the flight group with the controlling unmanned aerial vehicle.

The apparatus may be caused to receive an instruction from the controlling unmanned aerial vehicle to start coordinating flights of unmanned aerial vehicles in the flight group.

The apparatus may be caused to transmit an indication that the unmanned aerial vehicle in the flight group has not received flight control information from the controlling unmanned aerial vehicle for a predetermined time.

The indication may be transmitted to at least one of: the controlling unmanned aerial vehicle; and a ground-based controller.

According to an eleventh aspect, there is provided a computer program comprising program instructions for causing a computer to perform any method as described above.

According to a twelfth aspect, there is provided a computer program product stored on a medium may cause an apparatus to perform any method as described herein.

According to a thirteenth aspect, there is provided an electronic device that may comprise apparatus as described herein.

According to a fourteenth aspect, there is provided a chipset that may comprise an apparatus as described herein.

### BRIEF DESCRIPTION OF FIGURES

Examples will now be described, by way of example only, with reference to the accompanying Figures in which:

FIG. 1 shows a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIGS. 5 to 9 are flow charts showing example operations of described apparatuses.

### DETAILED DESCRIPTION

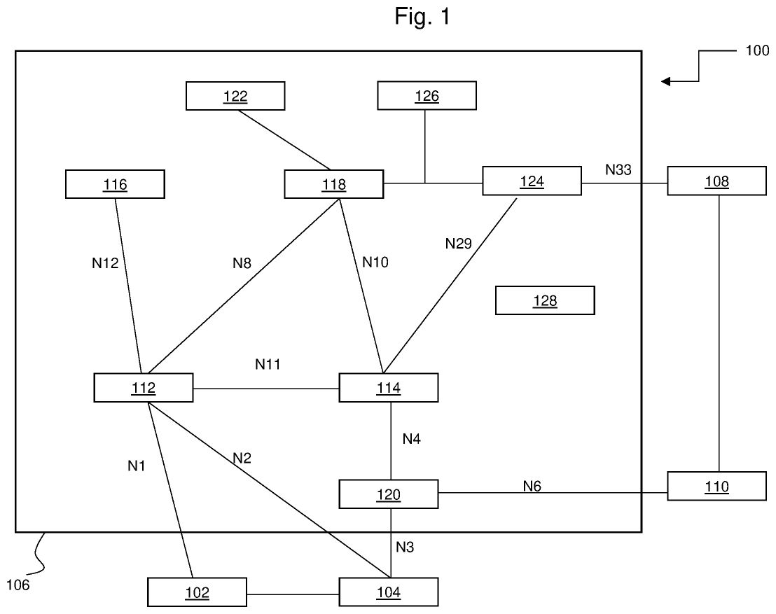

In the following, certain examples are explained with reference to mobile communication devices capable of communication via a wireless cellular system and mobile communication systems serving such mobile communication devices. Before explaining in detail the exemplifying mechanisms, certain general principles of a 5G wireless communication system are briefly explained with reference to FIG. 1.

FIG. 1 shows a schematic representation of a 5G system (5GS) 100. The may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) centralized unit functions. The RAN may comprise one or more access nodes.

The 5GC 106 may comprise one or more access management functions (AMF) 112, one or more session management functions (SMF) 114, one or more authentication server functions (AUSF) 116, one or more unified data management (UDM) functions 118, one or more user plane functions (UPF) 120, one or more unified data repository (UDR) functions 122, one or more policy control functions (PCF) 128, and/or one or more network exposure functions (NEF) 124. Although PCF 128 is not depicted with its interfaces, it is understood that this is for clarity reasons and that PCF 128 may have a plurality of interfaces with other network functions, such as AMF 112 (via interface N15), SMF 114 (via interface N7), UDR 122 (through interface N36), network data analytics function (NWDAF) 126 (through interface N23), and many other network functions.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

The 5G communication system, like previous generations of communication networks, has been designed to provide connectivity in an essentially bi-dimensional space. In other words, network access points are deployed to offer connectivity to devices on the ground, so network provision is effectively provided within a two-dimensional plane.

In contrast, evolved 5G and future 6G heterogeneous architectures are envisioned to provide three-dimensional coverage by complementing terrestrial infrastructures with non-terrestrial platforms such as unmanned aerial vehicles (UAVs) like drones, balloons, and satellites. Moreover, these elements could also be quickly deployed to guarantee seamless service continuity and reliability, for example in rural areas or during events and emergencies. This may help avoid the operational and management costs of always-on, fixed infrastructures. Despite such promising opportunities, there are various challenges to be solved before flying platforms can effectively be used in wireless networks. These include topology and trajectory optimization, and resource management.

One of the issues to be addressed with UAV usage is how to ensure the flying objects will accurately fly from an initial base to the target area (in latitude, longitude and altitude) to provide the required services. The most straightforward method would be to perform the flight control for each UAV individually, for example, using the Global Positioning System (GPS) and Artificial Intelligence (AI) capabilities included in each UAV to ensure it will precisely arrive at its target position. However, this method of flight control is not energy efficient when multiple UAVs are flying to the same target position, as energy is used by each of the UAVs for flight control.

One mechanism to address this would be to use the AI in one terminal control unit or one of the UAV in the group as a group leader. The terminal control unit or UAV group leader may acquire flight shapes formed using flight positions of the multiple flying objects and information configured with the positions of the flight shapes to calculate a parameter for guidance towards the respective positions of the multiple flying objects among the positions forming the flight shapes. This parameter may be used to instruct the flight control of the multiple flying objects. With this method, most of the energy usage for flight control is in the terminal control unit or UAV group leader, while the other UAVs can just follow the instruction without using their energy on determining a navigational path, e.g., their GPS and AI capabilities.

As the flight control is centralized at the terminal control unit or UAV group leader and there is no provision for the flight control to be shared within the flying object group. This create a single point of failure for flight control and energy usage for flight control using AI would drain the power source of the UAV group leader during the flight of the flying object group.

The following addresses at least one of the above described problems by allowing the flight control to be shared with at least one UAV in the flying object group. When at least one certain predetermined criterion is met, for example, a certain time or distance has passed since the flight started or a certain energy threshold is reached, the UAV group leader may send a ‘ready-to-delegate’ indication to at least one UAV in the flying object group. Each UAV that receives the indication may then decide whether it is ready to be the group leader based on its own conditions, for example, GPS and AI capabilities or energy level.

Each UAV that decides it is ready to be the group leader may send a ‘ready-to-lead’ indication comprising its identity (ID) to the UAV group leader. Based on the received ‘ready-to-lead’ indication(s) and other available information, for example, a predetermined priority among the ‘ready-to-lead’ UAVs or the current position or energy status of them, the UAV group leader may determine the next group leader and then send the ‘next group leader ID’ to the flying object group.

The new UAV group leader may take the flight control responsibility from the original/current one. The current and next UAV group leader may swap their physical positions in the flying object group to ensure the UAV group leader is located in the position within the flying object group to minimize the required transmission power for the UAV group leader to communicate with other UAVs in the flying object group, for example, at the centre of a circle flight shape of the flying object group.

Further examples of this mechanism will be provided in the following specific examples before a more general overview is provided. It is understood that these are non-limiting.

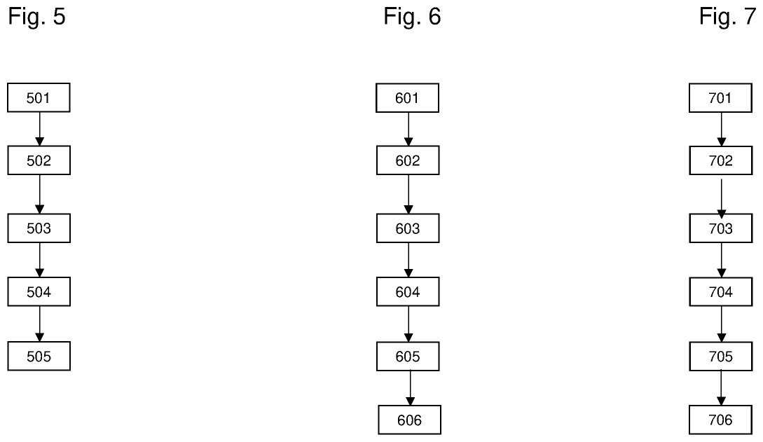

The first example is described with reference to the flow chart of FIG. 5.

In this first example, the group leader sequence has been determined before the flight, for example, using the processing and power capabilities of each UAV.

In this case, at 501 the at least one certain predetermined criterion is met (e.g. a certain time or distance has passed since the flight started or a certain energy threshold is reached), and the current UAV group leader sends a ‘ready-to-delegate’ indication, with the ID of the intended recipient, to the next UAV in the group leader sequence.

At 502, the UAV that receives the indication will determine whether it is ready to be the group leader based on its own conditions. For example, the recipient UAV may decide whether it is ready to be a group leader based on its GPS and AI capabilities or energy level. If the UAV decides that it is ready to be the group leader, it will then send a ‘ready-to-lead’ indication to the current UAV group leader within a certain predetermined period of time.

When the current UAV group leader does not receive the reply from the UAV next in the group leader sequence within the certain predetermined period, the current UAV group leader may send a ‘ready-to-delegate’ indication to the subsequent UAV(s) in the group leader sequence. The above described mechanism may thus repeat with the subsequent UAV(s) until a positive reply is received by the current UAV group leader.

At 503, the current UAV group leader receives a positive reply from a UAV, and sends an identifier for the positively responding UAV to the flying object group along with an indication that this is an identifier for a new group leader ID.

At 504, the next/future UAV group leader may physically move their position to ensure that the new/future UAV group leader is located in an energy efficient position within the flying object group for minimizing the required transmission power for the UAV group leader to communicate with other UAVs in the flying object group. This may mean taking the place of the current UAV group leader. The current UAV group leader may take the new/future UAV group leaders old position in the flying group object. In other words, at 504 the next/future UAV group leader and the current UAV group leader may swap positions in the flying group object.

At 505, the new UAV group leader (i.e. the positively responding UAV) may take the flight control responsibility from the original one.

In a second example, the current group leader may comprise a “group leader list” of UAVs that may become group leaders of the flying object group navigated by the current group leader. This list may have been determined before the flight using, for example, the processing and power capabilities of each UAV. This example is illustrated with respect to the flow chart of FIG. 6.

At 601, the at least one certain predetermined criterion is met (e.g. a certain time or distance has passed since the flight started or a certain energy threshold is reached), and the current UAV group leader sends a ‘ready-to-delegate’ indication to all UAVs in the group leader list.

At 602, each UAV that receives the ‘ready-to-delegate’ indication may then determine whether it is ready to be the group leader based on its own conditions (for example, GPS and AI capabilities or energy level).

At 603, each UAV that decides that it is ready to be the group leader may send a ‘ready-to-lead’ indication to the current UAV group leader. Each “ready-to-lead” indication may comprise an identifier of the UAV that sent it.

At 604, based on the received ‘ready-to-lead’ indication(s) and other available information (for example, the predetermined priority among the ‘ready-to-lead’ UAVs or the current position or energy status of them), the current UAV group leader may determine the next group leader and send the ‘next group leader ID’ to the flying object group.

At 605, the current and next UAV group leaders may swap their positions to ensure that the UAV group leader is located in a position within the flying object group that would minimize the required transmission power for the UAV group leader to communicate with other UAVs in the flying object group, for example, at the centre of a circle flight shape. This may be as described above in relation to FIG. 5.

At 606, the new UAV group leader will take the flight control responsibility from the original/current UAV group leader.

A third example is described with reference to FIG. 7. In this third example, at 701 at least one certain predetermined criterion is met (for example, a certain time or distance has passed since the flight started or a certain energy threshold is reached), and the UAV group leader sends a ‘ready-to-delegate’ indication to all UAVs in the flying object group.

At 702, each UAV that receives the ‘ready-to-delegate’ indication may determine whether it is ready to be the group leader based on its own conditions (for example, GPS and AI capabilities or energy level).

At 703, each UAV that decides that it is ready to be the group leader may send a ‘ready-to-lead’ indication to the current UAV group leader. Each “ready-to-lead” indication may comprise an identifier of the UAV that sent it.

At 704, based on the received ‘ready-to-lead’ indication(s) and other available information, for example, the predetermined priority among the ‘ready-to-lead’ UAVs or the current position or energy status of them, the current UAV group leader may determine the next group leader and then send the ‘next group leader ID’ to the flying object group.

At 705, the current and next UAV group leaders may swap their positions to ensure that the UAV group leader is located in a position within the flying object group that would minimize the required transmission power for the UAV group leader to communicate with other UAVs in the flying object group, for example, at the centre of a circle flight shape. This may as described above in relation to FIG. 5.

At 706, the new UAV group leader will take the flight control responsibility from the original one.

In all of the above discussed examples, a UAV that sends a ‘ready-to-lead’ indication may also send information on at least one of its own conditions, for example, GPS and AI capabilities or energy level. The current UAV group leader may use any such sent condition information to determine the next group leader.

In all of the above discussed examples, the current UAV group leader may issue flight control commands to direct the next UAV group leader to a certain position within the flight shape to swap its position with the next UAV group leader, with the current UAV group leader itself flying to another position within the flight shape. As indicated above, the term “swap” is used here to indicate that the next UAV group leader may take a position in the flying object group for minimising the average energy used for transmitting to members of the flying object group while the current UAV group leader takes another physical position in the flying object group. The physical position may be a relational physical position in that it is defined relative to at least one other object in the flying object group. This relational physical position may be useful since the flying object group will be moving with respect to at least one dimension.

In all of the above discussed examples, a UAV may send a ‘connection-lost’ indication to its current UAV group leader. A “connection-lost” indication may indicate that the sending UAV has not received any flight control commands nor any ‘ready-to-delegate’ indication from its UAV group leader for a certain time period. In response to receiving this ‘connection-lost’ indication, the current UAV group leader may take remedial action(s), for example, by increasing its transmit power for a certain period.

In all of the above discussed examples, a UAV may send a ‘connection-lost’ indication to its ground controller, for example, the controlling terminal. A “connection-lost” indication may indicate that the sending UAV has not received any flight control commands nor any ‘ready-to-delegate’ indication from its UAV group leader for a certain time period. After receiving this ‘connection-lost’ indication, the ground controller may take the necessary remedial action(s), for example, by asking the corresponding UAV group leader to increase its transmit power for a certain period.

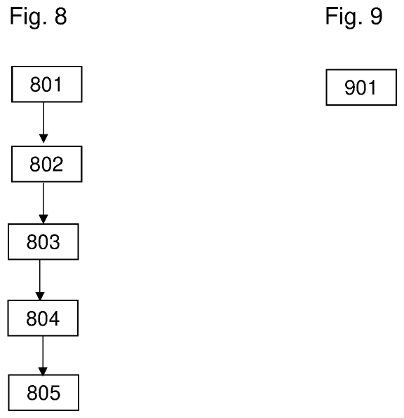

FIGS. 8 and 9 are flow charts illustrating some general operations of apparatuses described herein, such as apparatuses acting as objects within a flying object group.

FIG. 8 is a flow chart showing potential actions that may be taken by a UAV (“the controlling UAV”) currently acting as a controller of flights of UAVs in a flight group comprising the controlling UAV. For example, the controlling UAV may control a flight of a UAV by controlling a flight path of that UAV and/or any other aspects of controlling the operations of that UAV while that UAV is in motion. At least one of the UAVs in the flight group may act as an access point to a communication network for a terminal, such as a user equipment. Any of the UAVs in the flight group may act as an access point to a communication network for the terminal.

At 801, the controlling UAV coordinates the flights of UAVs in the flight group. This may comprise sending instructions to the UAVs in the flight group that causes the UAVs in the flight group to move to respective coordinates in a three dimensional space. These instructions may be sent periodically. These instructions may be sent aperiodically. These instructions may be sent using a combination of periodic and aperiodic transmissions. The aperiodic transmissions may be made in response to detection of an object in the flight path of at least one of the UAVs in the flight group.

At 802, the controlling UAV sends at least one request to at least one of the UAV for a new controller of the flight group.

The at least one request may initially be sent to a single UAV in the flight group. In such a case, if a response isn't received from the single UAV within a predetermined time frame, the controlling UAV may send the at least one request to another UAV in the flight group.

The at least one request may be sent to a single UAV in the flight group. The at least one request may be sent to a plurality (i.e. more than one) of the UAV comprised in a “potential leader” list stored by the controlling UAV. In such a case, the at least one request may be multicast.

The at least one request may be sent to all of the UAVs in the flight group. In such a case, the at least one request may be broadcast.

At 803, the controlling UAV may receive at least one response to the at least one request. Less than all of the UAV may respond to the request transmitted at 802. The controlling UAV may ignore any responses received after a predetermined period of time.

Each of said at least one response comprises a respective identifier of the UAV that sent said at least one response.

At 804, the controlling UAV may select one of the at least one UAV to be the new controller of the flight group using the at least one response.

At least one of said at least one responses may comprise information on at least one state of the UAV associated with the at least one response. In such a case, the selecting may comprise selecting said UAV using the information on at least one state. The at least one state may comprises any of: a battery level of the associated UAV; a processing capability of the associated UAV; artificial intelligence capabilities of the associated UAV; and global positioning system capabilities of the associated UAV.

At 805, the controlling UAV may send an identifier of the new controller to the UAVs. The identifier may be the identifier included in the response received at 803.

The controlling UAV may control the flight of the new controller to take a central position within the flight group. This central position may be a position that minimizes energy requirements for the new controller to communicate with UAVs in the flight group. This central position may be a position currently and/or previously occupied by the controlling UAV. The controlling UAV may take another position in the flight group to account for this change in position in the new controller. In one example, the controlling UAV may control the flight of the new controller to swap positions in the flight group with the controlling UAV. As discussed in the above examples, the “positions” may be considered as relative positions in the flight group.

The controlling UAV may instruct the new controller to start coordinating flights of UAVs in the flight group. This instruction may cause the new controller to start coordinating the flights of UAVs in the flight group after the new controller has started to (or has) assumed a new relative physical location in the flight group.

The controlling UAV may receive an indication that a first UAV in the flight group has not received flight control information from the apparatus for a predetermined time. Flight control information received by a UAV may be considered as control information for controlling the flight of that UAV. The indication may be received from the first UAV. The indication may be received from a ground-based controller. The controlling UAV may send flight control information to the first UAV using a transmission that increases the likelihood of reception by the first UAV relative to previous transmissions to the first UAV. For example, the controlling UAV may move closer to the first UAV to increase likelihood of transmissions, the controlling UAV may transmit to the first UAV using a higher transmission power than previous transmissions, the controlling UAV may transmit the first UAV using a more reliable transmission format (e.g. a different modulation and coding scheme) relative to previous transmissions, etc.

FIG. 9 illustrates potential operations that may be performed by a UAV in the flight group that interacts with the controlling UAV of FIG. 8. The UAV performing the actions of FIG. 9 may be configured to act as an access point to a communication network for a terminal, such as a user equipment.

At 901 for receiving an identifier of a new controller of a flight group comprising the UAV from a controlling UAV configured to coordinate flights of UAVs in the flight group. As mentioned above, the controlling UAV may control a flight of a UAV by controlling a flight path of that UAV and/or any other aspects of controlling the operations of that UAV while that UAV is in motion.

Before receiving the identifier, the UAV may receive a request to be the new controller from the controlling UAV. The UAV may determine whether (or not) to volunteer to be the new controller. The UAV may transmit the result of said determining to the controlling UAV along with an identifier for said UAV.

Said result of said determining may be transmitted with information on at least one state of the UAV. The at least one state may comprises any (i.e. at least one) of: a battery level of the UAV; a processing capability of the UAV; artificial intelligence capabilities of the UAV; and global positioning system capabilities of the UAV.

The apparatus may receive an instruction from the controlling UAV to take a central position within the flight group. In other words, the controlling UAV may control the flight of the UAV to take a central position within the flight group. This central position may be a position that minimizes energy requirements for the new controller to communicate with UAVs in the flight group. This central position may be a position currently and/or previously occupied by the controlling UAV. The controlling UAV may take another position in the flight group to account for this change in position of the UAV. In one example, the controlling UAV may control the flight of the UAV to swap positions in the flight group with the controlling UAV. As discussed in the above examples, the “positions” may be considered as relative positions in the flight group.

The controlling UAV may instruct the UAV to start coordinating flights of UAVs in the flight group. This instruction may cause the UAV to start coordinating the flights after the new controller has started to (or has) assumed a new relative physical location in the flight group.

The UAV may transmit an indication that the UAV in the flight group has not received flight control information from the controlling UAV for a predetermined time. Flight control information received by a UAV may be considered as control information for controlling the flight of that UAV. The indication may be transmitted to at least one of: the controlling UAV; and a ground-based controller. The UAV may receive a transmission from the controlling UAV as a result of transmitting this indication.

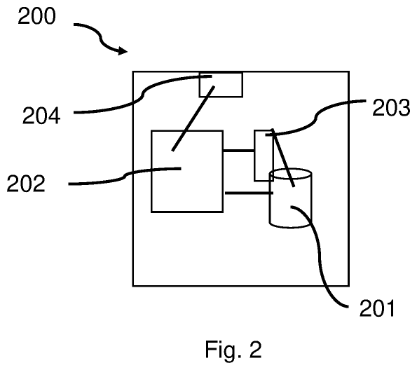

FIG. 2 shows an example of a control apparatus for a communication system, for example to be coupled to and/or for controlling a station of an access system, such as an access node, e.g. a base station, gNB, a central unit of a cloud architecture or a node of a core network such as an MME or S-GW, a scheduling entity such as a spectrum management entity, or a server or host, for example an apparatus hosting an NWDAF, AMF, SMF, UDM/UDR etc. The control apparatus may be integrated with or external to a node or module of a core network or Radio Access Network (RAN) Node. In some examples, base stations comprise a separate control apparatus unit or module. In other examples, the control apparatus can be another network element such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example the control apparatus 200 or processor 201 can be configured to execute an appropriate software code to provide the control functions.

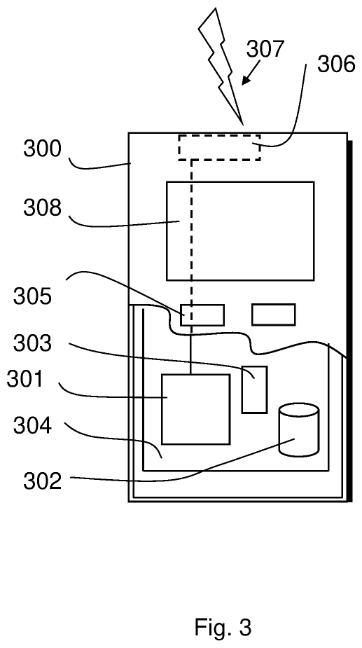

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference or 304. The user may control the operation of the wireless device by means of a suitable user interface such as key pad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories, for example hands-free equipment, thereto.

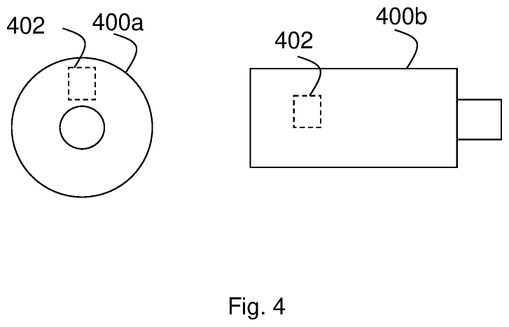

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIGS. 9 to 10.

The examples may thus vary within the scope of the attached claims. In general, some examples may be implemented in hardware or special purpose circuits, software, logic or any combination thereof. For example, some aspects may be implemented in hardware, while other aspects may be implemented in firmware or software which may be executed by a controller, microprocessor or other computing device, although examples are not limited thereto. While various examples may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures, e.g., as in FIGS. 9 to 10, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some examples may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some examples. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus for an unmanned aerial vehicle, the apparatus comprising;
at least one processor; and
at least one memory comprising computer code that, when executed by the at least one processor, cause the apparatus to perform at least the following:
coordinating flights of unmanned aerial vehicles in a flight group comprising the unmanned aerial vehicle;
transmitting at least one request to at least one of the unmanned aerial vehicles for a new controller of the flight group, wherein the new controller is to take over coordinating said flights from the unmanned aerial vehicle;
receiving at least one response to the at least one request;
selecting one of the at least one of unmanned aerial vehicles to be the new controller of the flight group using the at least one response; and
sending an identifier of the new controller to the unmanned aerial vehicles.

2. An apparatus as claimed in claim 1, wherein each of said at least one response comprises a respective identifier of the unmanned aerial vehicle that sent said at least one response.

3. An apparatus as claimed in claim 1, wherein at least one of said at least one responses comprises information on at least one state of the unmanned aerial vehicle associated with the at least one response, and wherein said selecting comprises selecting said one of the at least one of the unmanned aerial vehicles using the information on the at least one state.

4. An apparatus as claimed in claim 3, wherein the at least one state comprises any of: a battery level of the associated unmanned aerial vehicle; a processing capability of the associated unmanned aerial vehicle; artificial intelligence capabilities of the associated unmanned aerial vehicle; and
global positioning system capabilities of the associated unmanned aerial vehicle.

5. An apparatus as claimed in claim 1, wherein the at least one memory and the computer code, when executed by the at least one processor, cause the apparatus to perform controlling a flight of the new controller to take a central position within the flight group.

6. An apparatus as claimed in claim 1, wherein the at least one memory and the computer code, when executed by the at least one processor, cause the apparatus to perform swapping positions in the flight group with the new controller.

7. An apparatus as claimed in claim 1, wherein the at least one memory and the computer code, when executed by the at least one processor, cause the apparatus to perform instructing the new controller to start coordinating the flights of the unmanned aerial vehicles in the flight group.

8. An apparatus as claimed in claim 1, wherein the at least one memory and the computer code, when executed by the at least one processor, cause the apparatus to perform at least the following:
receiving an indication that a first unmanned aerial vehicle in the flight group has not received flight control information from the apparatus for a predetermined time; and
sending flight control information to the first unmanned aerial vehicle using a transmission that increases a likelihood of reception by the first unmanned aerial vehicle relative to a previous transmissions to the first unmanned aerial vehicle.

9. An apparatus as claimed in claim 8, wherein the indication is received from at least one of: the first unmanned aerial vehicle; and a ground-based controller.

10. An apparatus for an unmanned aerial vehicle, the apparatus comprising;
at least one processor; and
at least one memory comprising computer code that, when executed by the at least one processor, cause the apparatus to perform at least the following:
receiving an identifier of a new controller of a flight group comprising the unmanned aerial vehicle from a controlling unmanned aerial vehicle configured to coordinate flights of unmanned aerial vehicles in the flight group, wherein the new controller is to take over coordinating said flights from the controlling unmanned aerial vehicle.

11. An apparatus as claimed in claim 10, wherein the at least one memory and the computer code, when executed by the at least one processor, cause the apparatus to perform at least the following;
receiving a request to be the new controller from the controlling unmanned aerial vehicle;
determining whether to volunteer to be the new controller; and
transmitting the result of said determining to the controlling unmanned aerial vehicle along with an identifier for said unmanned aerial vehicle.

12. An apparatus as claimed in claim 11, wherein said result of said determining is transmitted with information on at least one state of the unmanned aerial vehicle.

13. An apparatus as claimed in claim 12, wherein the at least one state comprises any of: a battery level of the unmanned aerial vehicle; a processing capability of the unmanned aerial vehicle; artificial intelligence capabilities of the unmanned aerial vehicle; and global positioning system capabilities of the unmanned aerial vehicle.

14. An apparatus as claimed in claim 10, wherein the at least one memory and the computer code, when executed by the at least one processor, cause the apparatus to perform receiving an instruction from the controlling unmanned aerial vehicle to take a central position within the flight group.

15. An apparatus as claimed in claim 10, wherein the at least one memory and the computer code, when executed by the at least one processor, cause the apparatus to perform receiving an instruction from the controlling unmanned aerial vehicle to swap positions in the flight group with the controlling unmanned aerial vehicle.

16. (canceled)

17. An apparatus as claimed in claim 10, wherein the at least one memory and the computer code, when executed by the at least one processor, cause the apparatus to perform:
transmitting an indication that the unmanned aerial vehicle in the flight group has not received flight control information from the controlling unmanned aerial vehicle for a predetermined time.

18. (canceled)

19. A method for an apparatus for an unmanned aerial vehicle, the method comprising;
coordinating flights of unmanned aerial vehicles in a flight group comprising the unmanned aerial vehicle;
transmitting at least one request to at least one of the unmanned aerial vehicles for a new controller of the flight group, wherein the new controller is to take over coordinating said flights from the unmanned aerial vehicle;
receiving at least one response to the at least one request;
selecting one of the at least one of unmanned aerial vehicles to be the new controller of the flight group using the at least one response; and
sending an identifier of the new controller to the unmanned aerial vehicles.

20. A method for an apparatus for an unmanned aerial vehicle, the method comprising;
receiving an identifier of a new controller of a flight group comprising the unmanned aerial vehicle from a controlling unmanned aerial vehicle configured to coordinate flights of unmanned aerial vehicles in the flight group, wherein the new controller is to take over coordinating said flights from the controlling unmanned aerial vehicle.

21. (canceled)

22. (canceled)
